(19) United States
(12) Patent Application Publication
(10) Pub. No.: US 2004/0221048 A1
(43) Pub. Date: Nov. 4, 2004

(54) Email archive system

(76) Inventor: Rohan Anthony Ogier, Victoria (AU)

Correspondence Address: NIXON & VANDERHYE, PC, 1100 N GLEBE ROAD, 8TH FLOOR, ARLINGTON, VA, 22201-4714, US

(21) Appl. No.: 10/485,359

(22) PCT Filed: Aug. 1, 2002
(86) PCT No.: PCT/AU02/01024

(30) Foreign Application Priority Data
Aug. 1, 2001 (AU) 2001100219

(51) Int. Cl. G06F 15/16

(52) U.S. Cl. 709/229

(57) ABSTRACT

An email archive system which is independent of the sender and receiver systems. The archive system provides an outgoing email server for the sender systems through which outgoing messages pass. Outgoing messages are archived according to rules set up for particular senders. Contents of the archive are not directly accessible even by the senders and copies of stored messages are retrieved on request.

### FIELD OF THE INVENTION

This invention relates to archive systems for electronic documents that are transmitted between remote sender and receiver systems, particularly but not only to archives for storing copies of email messages that are transmitted over the Internet by the sender systems.

### BACKGROUND TO THE INVENTION

A range of archive systems for email messages are in existence, although none are reliably independent of the sender systems in which they operate. All of the available archive systems are implemented either within or directly in relation to their sender systems, and the messages that they store are readily accessible by the sender systems. There are no simple general systems that enable transmission of emails between commercial entities, for example, where the senders and receivers are able to obtain reliable copies of the emails at a later date.

### SUMMARY OF THE INVENTION

It is an object of the present invention to provide an improved archive system for email messages, or at least to provide a useful choice over existing systems.

In one aspect the invention consists in a method of archiving electronically transmitted messages, comprising: establishing an archive server system in a communications network, predetermining a plurality of remote sender systems from which messages will be archived, receiving messages from the sender systems over the network, forwarding the messages to remote recipient systems identified in the messages, and storing at least some of the messages and related details in the archive. Preferably the method includes receiving requests from the sender systems for copies of archived messages and details, and forwarding the copies to remote systems identified in the requests.

In another aspect the invention consists in an archive system for electronic messages, comprising: a mailbox for messages received from a plurality of predetermined sender systems, a sorter subsystem that sorts messages in the mailbox according to their sender identities, a transmission subsystem that forwards messages from the mailbox to receiver systems identified in the messages, an archiver subsystem that stores copies of the forwarded messages and related details in an archive database, and a retrieval subsystem that retrieves and sends copies of the archived messages to nominated receivers on request from the respective sender systems. Preferably a sender system is predetermined by a contract for services between the owner or operator of the sender system and an owner or operator of the archive system.

### LIST OF FIGURES

Preferred embodiments of the invention will be described with respect to the accompanying drawings, of which:

FIG. 1 shows a sender system transmitting electronic messages to a receiver system through an archive system,

FIG. 2 shows parts of the archive system that process the messages in FIG. 1,

FIG. 3 shows a sequence of typical events involving the sender, receiver and archive systems, and

FIG. 4 shows an embodiment in which the sender and receiver systems communicate over the Internet and require involvement of ISPs.

### DESCRIPTION OF PREFERRED EMBODIMENTS

Referring to the drawings it will be appreciated that the invention may be implemented in many ways in relation to a variety of sender and receiver systems, and networks for communication between the systems. These embodiments are described as examples only. Details of the sender, receiver and communication systems will be understood by a skilled reader and need not be described in detail.

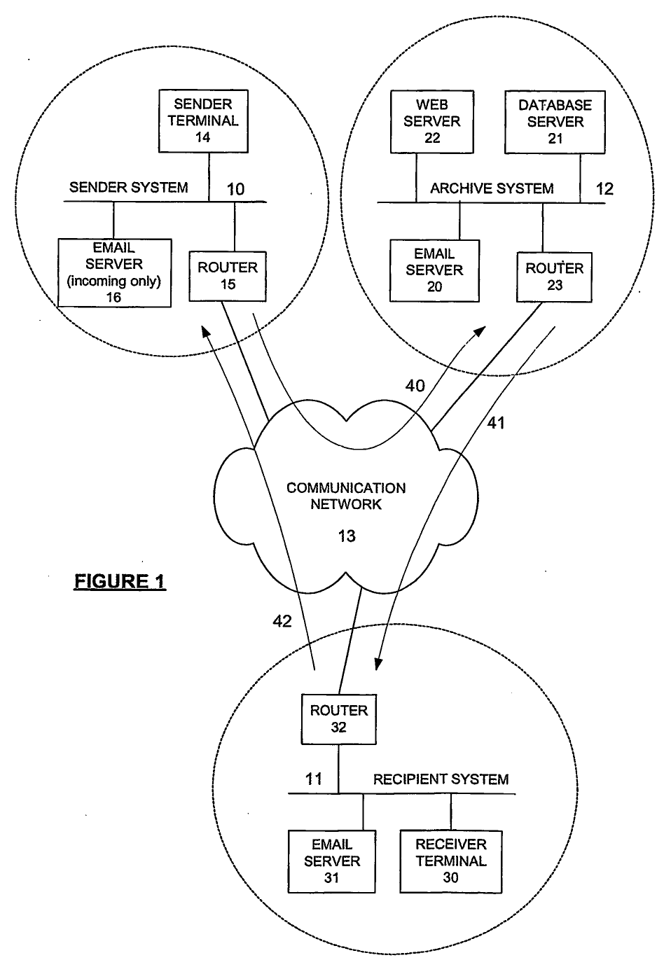

FIG. 1 shows a generalised arrangement for communication of email or other electronic documents between a sender system 10 and a receiver system 11. A communication network 13 such as the Internet connects the systems, which may be large corporate networks with many terminals and users for example, or single computers operated by private individuals. The sender system 10 transmits email messages through an archive system 12 that is operated independently of both the sender and receiver systems. The three systems 10, 11, 12 have separate local networks that are usually geographically remote from each other, and connected to the Internet through various devices such as routers. Many sender and receiver systems are usually present and provided with services by the archive system 12. An enormous range of different networks, configurations and connections exist and it will be appreciated that they are indicated in a highly generalised form only.

The sender system 10 in FIG. 1 has at least one local terminal 14 that is typically a desktop computer containing or having access to a range of software applications, including an email application. A user of the terminal is able to create, send and receive email messages to other computers either inside or outside the local network. Email messages in a network of this kind are normally sent and received through a local email server that provides a range of functions, including DNS (domain name system) lookup of addresses for the intended receiver systems, and tracking of message delivery. A gateway router 15 connects the local network to the wider communications network 13. Email daemons and other message transfer agents installed as software processes on the network are responsible for movement of the messages around the network. In this example, the system 10 has only an incoming email server 16 through which messages from other systems are received and distributed to the terminals.

The archive system 12 in FIG. 1 is a local network with a number of components including an email server 20, database server 21 and a web server 22. A router device 23 connects the archive system to the wider communications network 13. The archive system provides an archive service for the sender system 10 and usually a large number of sender systems that have not been shown. In particular, the archive system provides the email server 20 as an outgoing email server for each of the sender systems. The operators or owners of the sender systems form an arrangement and set up an account for services with the operator or owner of the archive system. The parties in these arrangements are independent in the sense that the network on which the archive system is based is operated by a party other than the operator of the network on which the sender systems are based, and an operator of one network has no access to the other networks. Email messages from the sender terminals are directed by their respective systems to use the email server 20 as an outgoing email server, rather than an email server on the local networks. The archive system stores copies of the messages according to predetermined rules of each account.

The receiver system 11 in FIG. 1 is also a local network and typically has a number of components including at least one user terminal 30 and an email server 31. A router 32 or similar device connects the local network to the wider communications network 13. In this example the receiver system has no arrangement with the archive system and all email messages incoming or outgoing to the receiver system are directed through the email server 31.

A simple email transmission sequence is indicated by the arrows in FIG. 1. An email from the sender system 10 is created at terminal 14, and directed by the local network to the email server 20 in the archive system 12 as indicated by arrow 40. The address of the server 20 is nominated as the destination to which the email is sent for email server functions. All emails sent by terminals in the system 10 are preferably directed in this way, and are created, addressed and transmitted in accord with protocols such as TCP (Transmission Control Protocol), IP (Internet Protocol) and SMTP (Simple Mail Transfer Protocol). A copy of the message is stored by the archive database server 21 usually according to the identity of the sender, as indicated by their email address. Details such as time, date and any attachments are also stored. Messages may or may not be archived according to a list of senders that is provided by the sender system 10, and updated in various ways, such as by email directly to the archive system 12, or by password access through the web server 22. The message is then transmitted by the archive system 12 to a receiver in a recipient system 11 stated by the sender, as indicated by arrow 41. A reply message from the recipient system 11 is sent directly to the sender system 10 as indicated by arrow 42, because the receiver system has no arrangement for services with the archive system.

Copies of messages may be obtained from the archive system 12 of FIG. 1 in a variety of ways, subject to the overall restriction that they may not be edited, or preferably even viewed in full, on the archive system itself. In one method of retrieval, an operator in the sender system, or other suitably authorised party, sends an email request for a particular message directly to the archive system. In another method, a particular message is selected from a list available via the web server 22. In general, the archive system will provide an ordered list of stored messages from which the authorised party may select, and may do so by regularly sending data on a compact disc or other medium, for example. A copy of the requested message is sent to an email address nominated by the authorised party. For example, a copy may be required simultaneously at the sender system and at the original receiver system to check the terms of a commercial agreement, or may be required by an entirely different party.

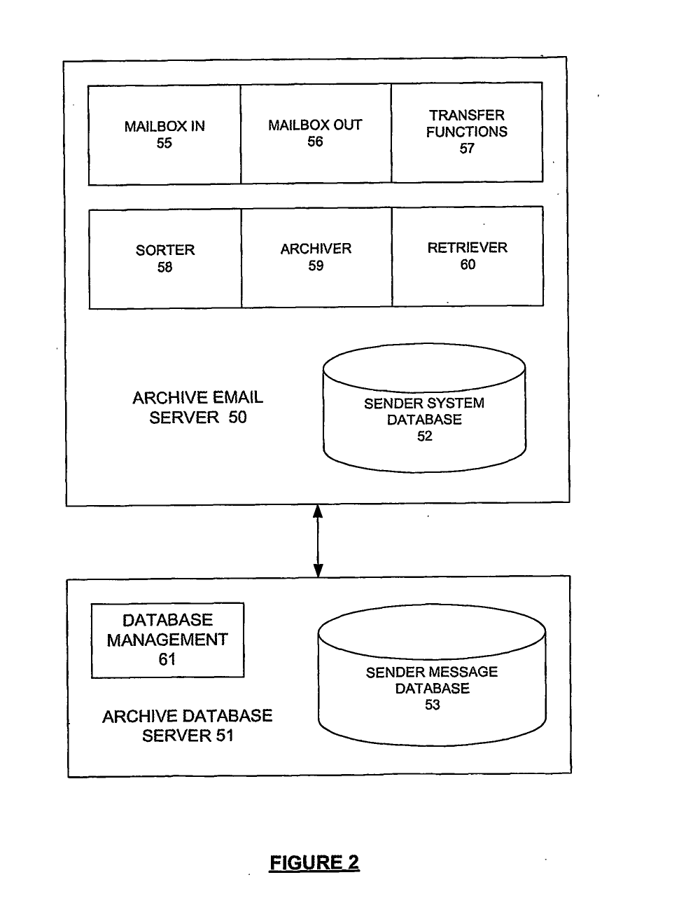

FIG. 2 shows software components of typical email and database servers 50 and 51 in the archive system 12 of FIG. 1, most of which will be automated in a fully functional system serving many sender systems. The email server components include generally standard electronic mailboxes 55 and 56 for incoming and outgoing email respectively, and a range of transfer functions 57 such as readers and senders are also provided. A sorter process 58 determines the origin of each message in the inbox and sorts by sender details stored in the sender database 52. An archiver process 59 transfers copies of those messages that are to be archived to an archive database 53. A retriever process 60 carries out functions associated with obtaining and dispatching copies of messages from the archive on behalf of authorised requests. The database server components include management processes 61. Other components of the archive system such as the web server will also be understood by a skilled person and need not be described in detail.

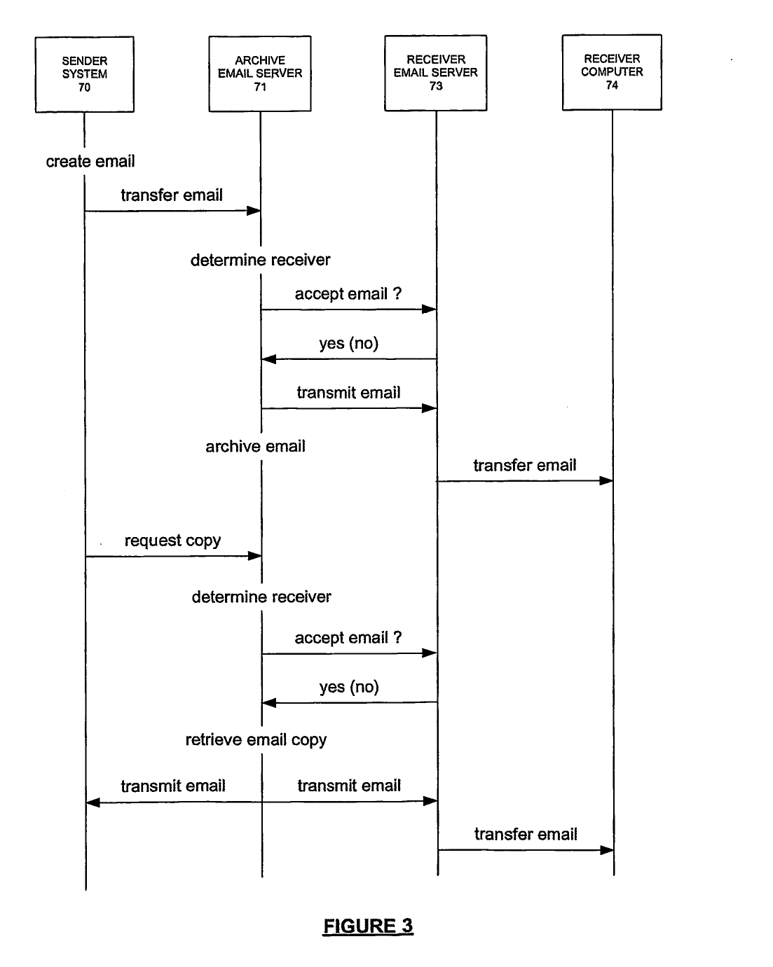

FIG. 3 is a sequence diagram that gives more detail of the flow of specific communications in the overall system of FIG. 1. It is important to note that the archive email server 70 is separate and independent of the sender system 71, although a receiver system may include both an email server 72 and receiver terminal 73 on the same local network or otherwise in a close relationship. An email application in the sender system creates an email addressed to a receiver, in a range of possible ways. The message is transferred from the sender system to the archive system, by nominating the email server in the archive network for example, as the outgoing email server of the sender system. A series of process at the archive email server including interaction with address servers in the wider communication network 13 determine how the email will be routed to the receiver. If the receiver address is incorrect or the receiver is unavailable for some reason, an appropriate “undeliverable” message will be sent to the archive email server and returned to the sender system. If the receiver is able to accept the email then the message is transmitted to an email server in the receiver system and from there transferred according to local network processes to the receiver terminal itself. A copy of the email as sent to the receiver system is stored in the archive system as described above, with details relevant to the communication.

A simple retrieval operation is also described in FIG. 1. A user in the sender system 70 requests that a copy of an earlier email be sent to an address, such as a mailbox, in the sender system 70 and to an address in the system that originally received the message, in this case simply the original receiver. The archive server 72 determines the ability of both systems to receive the message copies, and then retrieves and transmits emails to addresses specified in the request. An email copy is preferably an exact copy of the original message, with header information or perhaps a formal notice of verification.

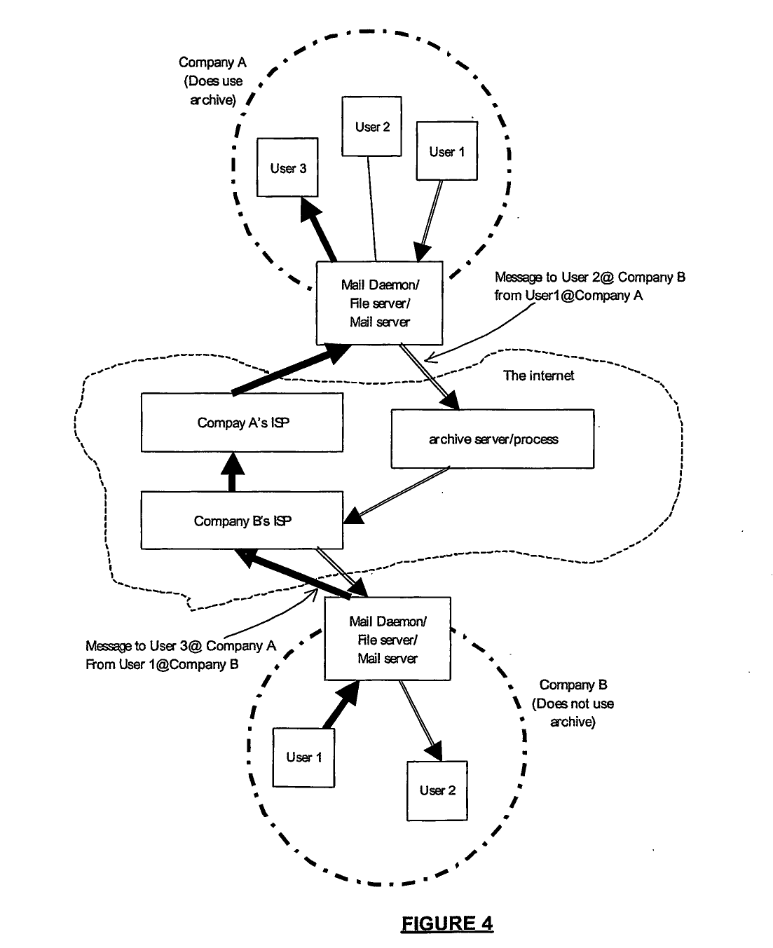

FIG. 4 is a specific example of message transmissions in a sender, archive and receiver arrangement connected by the Internet. Both of the sender and receiver systems use an email holding service provided by a respective ISP (Internet Service Provider). User1 in the network of Company A creates and transmits a message to User2 at Company B. The message from Company A passes through and is archived by a server process as described above, before reaching the network operated by Company B. A message from User 1 at Company B is also sent to User 3 at Company A, but because Company B has no arrangement with an archive service the message passes though ISP servers of each company in the usual way. Mail functions at each local network and their connection to the Internet may be provided in various ways, by mail daemon applications for example, or by more sophisticated file or mail servers.

1. A method of archiving electronically transmitted messages, comprising:
(a) establishing an archive server system in a communications network,
(b) predetermining a plurality of remote sender systems from which messages will be archived,
(c) receiving messages from the sender systems over the network,
(d) forwarding the messages to remote recipient systems identified in the messages, and
(e) storing at least some of the messages and related details in the archive.

2. A method according to claim 1 further comprising:
(f) receiving requests from the sender systems for copies of archived messages and details, and
(g) forwarding the copies to remote systems identified in the requests.

3. A method according to claim 1 further comprising:
selecting messages for storage according to identities of their senders within the respective sender systems.

4. A method according to claim 1 further comprising:
determining whether each message will be accepted by a recipient system before duplicating the message in the archive system.

5. A method according to claim 1 wherein the sender and recipient systems are computer networks operated by organisations that are independent of the archive system.

6. A method according to claim 1 wherein predetermining a sender system includes forming a contract for services between an owner or operator of the sender system and an owner or operator of archive system.

7. A method according to claim 1 wherein the communication network is the Internet and the electronically transmitted messages are email messages transmitted using SMTP or other Internet communication protocols.

8. A method according to claim 1 where details stored in the archive include date, sender, receiver, subject, attachment or other information about the message communicated between the sender and recipient systems.

9. A method according to claim 1 further comprising:
allowing a message to be inspected only by transfer of a copy of the message out of the system.

10. An archive system for electronic messages, comprising:
a mailbox for messages received from a plurality of predetermined sender systems,
a sorter subsystem that sorts messages in the mailbox according to their sender identities,
a transmission subsystem that forwards messages from the mailbox to receiver systems identified in the messages,
an archiver subsystem that stores copies of the forwarded messages and related details in an archive database, and
a retrieval subsystem that retrieves and sends copies of the archived messages to nominated receivers on request from the respective sender systems.

11. An archive system as in claim 10 wherein a sender system is predetermined by a contract for services between the owner or operator of the sender system and an owner or operator of the archive system.

12. An archive system as in claim 10 operated independently and remotely of all of the sender systems from which messages are received.

13. An archive system as in claim 10 including a server that operates as an email server for each of the sender systems.
